(19) United States
(12) Patent Application Publication
(10) Pub. No.: US 2008/0106054 A1
(43) Pub. Date: May 8, 2008

(54) Handle assembly and rolling cooler comprising same

(76) Inventor: Russell Brent Autry, Georgetown, TX (US)

Correspondence Address: DAVID ODELL SIMMONS, 7637 PARKVIEW CIRCLE, AUSTIN, TX, 78731, US

(21) Appl. No.: 11/594,631

(22) Filed: Nov. 8, 2006

(51) Int. Cl. B62B 5/06

(52) U.S. Cl. 280/47.315; 220/752; 220/739

(57) ABSTRACT

A rolling cooler comprises an insulated enclosure, wheels and a handle assembly. The insulated enclosure includes a main body and a cover. The cover is movable between an open configuration where an interior space of the insulated enclosure is accessible and a closed configuration whereby the cover substantially covers an opening defining the interior space of the insulated enclosure. The wheels are attached to the insulated enclosure for enabling the insulated enclosure to be moved along a support surface in a wheeled manner. The handle assembly is attached to the insulated enclosure. The handle assembly includes a hand-gripping portion configured for enabling a person to wrap fingers of one of their hands at least partially therearound and a beverage container holder including a container-receiving space in which a beverage container is stowable.

### FIELD OF THE DISCLOSURE

The disclosures made herein relate generally to rollable carrying cases and, more particularly, to handle assemblies and handle-mounted accessories for rolling coolers.

### BACKGROUND

Rollable carrying cases of various configurations are well known. Examples of such rollable carrying cases in the context of the present invention include, but are not limited to, rolling coolers, rolling luggage and the like. Examples of commercially available rolling coolers include, but are not limited to, those offered under brand names such as Igloo, Travellers Club, Cool Carry, Land's End and Picnic Time. Examples of commercially available rolling luggage include, but are not limited to, those offered under brand names such as Travel Pro, Samsonite, International Traveller, Land's End, L. L. Bean, Zeroller, JanSport and Boston Traveller.

In general, a rollable carrying case includes an enclosure having an interior space in which items may be stored, wheels attached to the enclosure for enabling the enclosure to be moved along a floor or ground surface in a wheeled manner (i.e., rolled along a support surface) and a handle assembly attached to the enclosure for enabling a person to pull and/or push the enclosure. By enabling the enclosure to be moved in a wheeled manner, the enclosure can be transported without having to carry it over long distances. Transporting the enclosure in a wheeled manner as opposed to carrying it greatly reduces discomfort and physical fatigue associated with carrying the enclosure, particularly when loaded with articles. Furthermore, such reduction in discomfort and physical fatigue allows the total cargo capacity of the enclosure to be increased accordingly.

Rolling luggage and rolling coolers both offer relief from discomfort and physical fatigue associated with having to otherwise carry the luggage or cooler. However, when compared to rolling luggage, rolling coolers are used more repeatedly in a wheeled manner. For example, when a spectator takes a rolling cooler to a sporting event such as a motorsport race or athletic event, they typically pull the rolling cooler around with them during the event whenever they leave their seat. In contrast, a traveller generally pulls their rolling luggage for only short distances while walking between parking lots, airport terminals and hotels. Furthermore, contents of a rolling cooler are accessed more frequently during a given timeframe than that of a rolling luggage. For example, when a spectator takes a rolling cooler to a motorsport event or athletic event, they will frequently access beverages and/or snacks within the rolling cooler during the duration of the event.

One shortcoming of rollable carrying cases is that the handle assembly is often relatively short with respect to relatively tall people, even when a retractable handle assembly is in a fully extended orientation. This causes a relatively tall person to have to lean to the side and/or backwards when pulling some rollable carrying cases. This leaning can lead to discomfort and fatigue, which diminishes at least some of the intended benefits of the rollable carrying case. The overall height of a hand-gripping portion of a retractable handle assembly is generally dependent upon an overall height of the enclosure to which it is attached because it is desirable for the hand-gripping portion to not protrude excessively above a top surface of the enclosure when the retractable handle assembly is in the fully retracted orientation. Accordingly, the overall height of an enclosure is often relatively low with respect to many people of average or above average height.

Therefore, a handle assembly that addresses shortcomings associated with conventional handle assemblies of rollable carrying cases and that enhances overall usefulness of rollable carrying cases would be advantageous, desirable and useful.

### SUMMARY OF THE DISCLOSURE

Embodiments of the present invention address shortcomings associated with conventional handle assemblies of rollable carrying cases, thereby enhancing overall usefulness of rollable carrying cases. More specifically, embodiments of the present invention extend the length of a handle assembly of a rollable carrying case. In doing so, comfort and convenience of use are enhanced, as taller persons no longer have the need to lean over or back as a result of a handle assembly height that is too low. Furthermore, convenience associated with holding an article such as, for example, a cell phone, a beverage or an ashtray is enhanced. Still further, a rollable carrying case in accordance with the present invention may be personalized through display of indicia that is preferred by a user of the rolling carrying case.

In one embodiment of the present invention, an accessory handle assembly is configured for attachment to a handle assembly of a rollable carrying case. The accessory handle assembly comprises a handle body, a mounting bracket structure and an article holder. The handle body includes a hand-gripping portion that enables a person to wrap fingers of one of their hands at least partially therearound. The mounting bracket structure is attached to the handle body and is fixedly attachable to a handle assembly of a rollable carrying case. The article holder is attached to the handle body.

In another embodiment of the present invention, a rollable carrying case comprises an enclosure, wheels and a handle assembly. The enclosure has an interior space in which items may be stored. The wheels are attached to the enclosure for enabling the enclosure to be moved along a support surface in a wheeled manner. The handle assembly is attached to the enclosure. The handle assembly includes a hand-gripping portion and a beverage container holder. The beverage container holder includes a container-receiving space in which a beverage container is stowable.

In another embodiment of the present invention, a rolling cooler comprises an insulated enclosure, wheels and a handle assembly. The insulated enclosure includes a main body and a cover. The cover is movable between an open configuration where an interior space of the insulated enclosure is accessible and a closed configuration whereby the cover substantially covers an opening defining the interior space of the insulated enclosure. The wheels are attached to the insulated enclosure for enabling the insulated enclosure to be moved along a support surface in a wheeled manner. The handle assembly is attached to the insulated enclosure. The handle assembly includes a hand-gripping portion configured for enabling a person to wrap fingers of one of their hands at least partially therearound and a beverage container holder including a container-receiving space in which a beverage container is stowable.

Turning now to specific aspects of the present invention, in at least one embodiment, the article holder is a beverage container holder and the beverage container holder includes a container-receiving space in which a beverage container is stowable.

In at least one embodiment of the present invention, an indicia article is attached to the handle body.

In at least one embodiment of the present invention, the indicia article includes indicia designating at least one of a number of a sport competitor, a number of a racing vehicle, a logo of a sport team and a name of a sport team.

In at least one embodiment of the present invention, the mounting bracket structure includes retention portions jointly engagable with a handle assembly of a rollable carrying case.

In at least one embodiment of the present invention, the retention portions are fixedly securable to each other for applying a retention force on an engaged portion of the handle assembly of the rollable carrying case thereby limiting movement of the handle body with respect to the handle assembly of the rollable carrying case.

In at least one embodiment of the present invention, the handle body includes a rectangular-shaped frame having an upper frame segment, a lower frame segment and spaced apart side frame segments connected between the upper frame segment and the lower frame segment thereby defining an opening between the frame segments.

In at least one embodiment of the present invention, the hand-gripping portion is integral with the upper frame segment, the mounting bracket structure is attached to the lower frame segment and the beverage container holder is attached one of the side edge portions.

In at least one embodiment of the present invention, the handle assembly includes a handle body and a telescoping structure connected between the handle body and the enclosure such that the telescoping structure is movable between a retracted configuration and an extended configuration.

These and other objects, embodiments, advantages and/or distinctions of the present invention will become readily apparent upon further review of the following specification, associated drawings and appended claims.

### BRIEF DESCRIPTION OF THE DRAWINGS

FIG. 1 is a front perspective view of an embodiment of a rolling cooler in accordance with the present invention, which has a handle assembly in an extended orientation and an insulated body cover in an open configuration.

FIG. 2 is a rear perspective view of an embodiment of a rolling cooler in accordance with the present invention, which has a handle assembly in an extended orientation and an insulated body cover in a closed configuration.

FIG. 3 is a front perspective view of an embodiment of a rolling cooler in accordance with the present invention, which has a handle assembly in a retracted orientation and an insulated body cover in a closed configuration.

### DETAILED DESCRIPTION OF THE DRAWING FIGURES

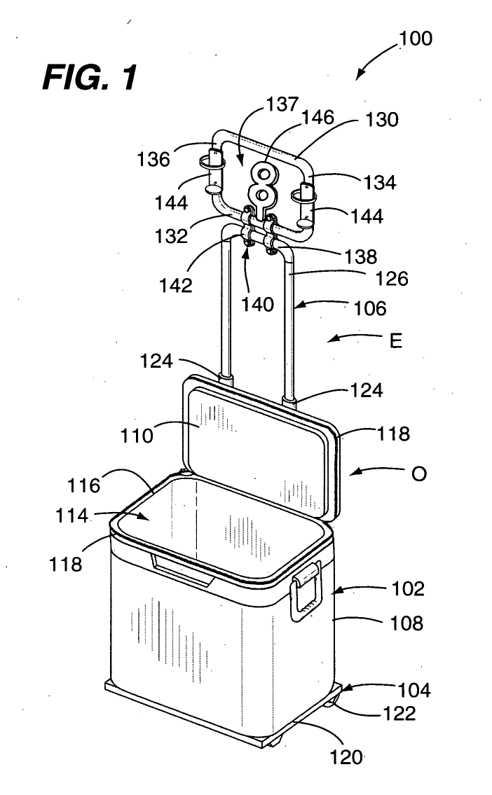

FIGS. 1-3 show an embodiment of a rolling cooler in accordance with the present invention, which is referred to herein as the rolling cooler 100. The rolling cooler 100 includes an insulated enclosure 102, a wheel assembly 104 and a handle assembly 106. The insulated enclosure 102, the wheel assembly 104 and the handle assembly 106 are interconnected for enabling a person to pull the insulated enclosure 102 along a support surface (e.g., the ground) in a wheeled manner. In doing so, a person does not have to lift and carry the insulated enclosure 102 when moving it from one location to another.

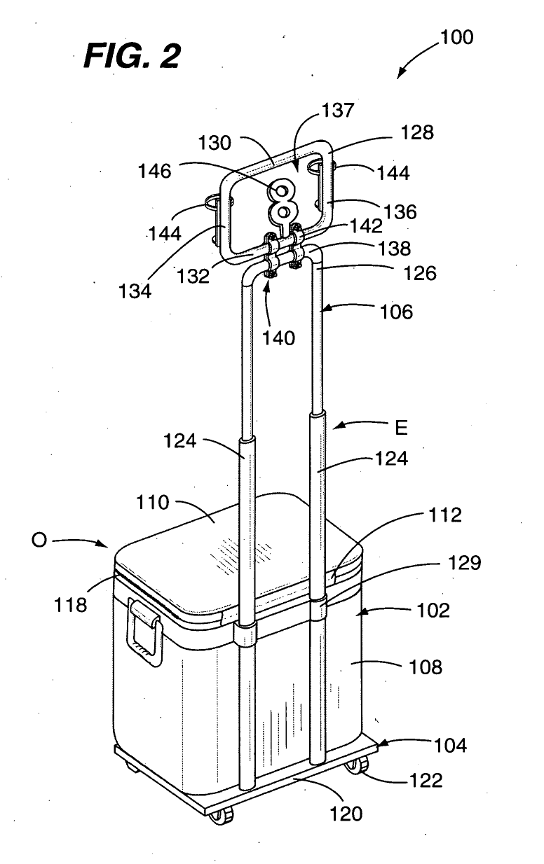

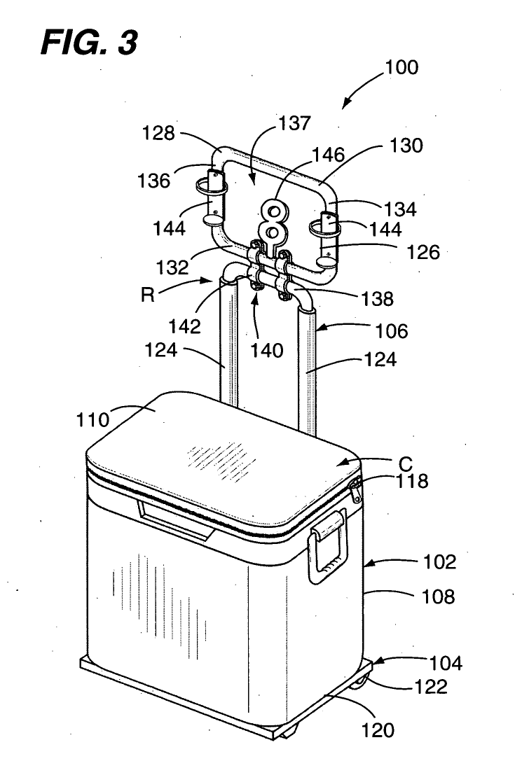

The insulated enclosure 102 includes a main body 108 and a cover 110. The cover 110 is movably attached to the main body 108 by a hinge 112 (FIG. 2) for enabling the cover to be movable between an open configuration O (FIG. 1) and a closed configuration C (FIGS. 2 and 3). With the cover 110 in the open configuration O, an interior space 114 of the insulated enclosure 102 is accessible through an opening 116 in the main body 108 that defines the interior space 114 of the insulated enclosure 102. With the cover 110 in the closed configuration C, the cover 110 substantially covers the opening 116 in the main body 108. A zipper assembly 118 (i.e., a closure mechanism) is provided between the main body 108 and the cover 110 for enabling the cover 110 to be secured in the closed orientation C.

The wheel assembly 104 includes a mounting structure 120 and a plurality of wheels 122. The insulated enclosure 102 is fixedly engaged with the mounting structure 120. The wheels 122 are rotatably attached to the mounting structure 120 such that the wheels 122 are engagable with an underlying support surface for enabling the insulated enclosure 102 to be moved along the support surface in a wheeled manner.

The handle assembly 106 includes spaced part lower leg members 124, an upper arm 126 and a handle body 128. The lower leg members 124 are fixedly attached to the mounting structure 120 of the wheel assembly 104 and to a handle engagement portion 129 (FIG. 2) of the insulated enclosure 102. The upper arm 126 is slideably attached to the lower leg members 124 for enabling the upper arm 126 to be moved between an extended configuration E with respect to the lower leg members 124 and a retracted configuration R with respect to the lower leg members 124. As shown in FIGS. 1-3, the upper arm 126 is telescopingly attached to the lower leg members 124. However, it is disclosed herein that the upper arm 126 may be movably attached to the lower leg members 124 in other arrangements (e.g., pivotably attached) that enable the upper arm 126 to be moved between the extended configuration E with respect to the lower leg members 124 and the retracted configuration R with respect to the lower leg members 124.

The handle body 128 is a rectangular-shaped frame having an upper frame segment 130, a lower frame segment 132 and spaced apart side frame segments (134, 136). The side frame segments (134, 136) are connected between the upper frame segment 130 and the lower frame segment 136. An opening 137 is defined between the frame segment (130-136). Although the handle body 128 shown in FIGS. 1-3 is a rectangular-shaped frame, a handle body in accordance with the present invention is not limited to a particular shape. For example, a handle body in accordance with the present invention may be rectangular, round, oval, triangular, or any other shape. Furthermore, a handle body in accordance with the present invention need not be in the form of a frame with an opening at its central region. In at least one embodiment of the present invention, the handle body has a generally closed central region with a hole therein through which a user extends his or her fingers for enabling their fingers to be wrapped around a hand-gripping portion of the handle body.

Still referring to FIGS. 1-3, the upper frame segment 130 of the handle body 128 serves as a hand-gripping portion configured for enabling a person to wrap fingers of one of their hands at least partially around. Preferably, but not necessarily, the upper frame segment 130 is specifically configured for enhancing hand-gripping functionality. Examples of such specific configuration includes, but is not limited, a padded hand-gripping surface and a contoured hand-gripping surface.

The handle body 128 is attached to a crossbar 138 of the upper arm 126 by a plurality of mounting bracket structures 140. In one embodiment (shown), the mounting bracket structures 140 each include mating clamp members 142 (i.e., retention portions) that jointly engagable with the crossbar 130 of the upper arm 126 and the lower frame segment 132 of the handle body 128. The crossbar 130 of the upper arm 126 and the lower frame segment 132 of the handle body 128 are sandwiched between the mating clamp members 142 of each one of the mounting bracket structures 140. The mating clamp members 142 are fixedly securable to each by a suitable fastening means (e.g., threaded fasteners, retention clips, etc) for applying a retention force on an engaged portion of the crossbar 130 and the lower frame segment 132 such that movement of the handle body 128 with respect to the upper arm 126 is substantially limited, if not precluded.

A beverage container holder 144 is attached to each side frame segment (134, 136) of the handle body 128. Each beverage container holder 144 includes a container-receiving space in which a beverage container is stowable. In at least one embodiment of the present invention, the beverage container holder 144 is specifically configured for holding conventional beverage bottles (e.g., water, sold and/or beer bottles) and/or beverage cans (e.g., water, sold and/or beer cans). A water bottle cage for a bicycle is an example of a beverage container holder that provides beverage container holding functionality in accordance with the present invention. It is disclosed herein that one of both of the beverage container holders 144 may be omitted in at least some embodiments of the present invention.

The beverage container holders 144 are each examples of article holders in accordance with the present invention. Other forms of article holders in accordance with the present invention include, but are not limited to, a cell phone holder, an ashtray or ashtray holder, a portable radio or television holder, a scanning device holder, etc. It is disclosed herein that one or more article holders may be attached to the handle body 128.

An indicia article 146 is attached to the handle body 128. Preferably, but not necessarily, the indicia article 146 includes indicia designating a number of a sport competitor, a number of a racing vehicle, a logo of a sport team and/or a name of a sport team. Such indicia allow a user of the rolling cooler 100 to express their preference for a specific competitor, racing vehicle and/or sport team. However, the present invention is not unnecessarily limited to a particular indicia article of indicia provides on that indicia article. For example, the indicia article may be an applique (e.g., sticker, screen printing, etc) that is applied to an integral or discrete indicia carrying body that is attached to the handle body (e.g., disposed within a space defined between the frame segment (130-136)). Furthermore, it is disclosed herein that the indicia article 146 may be omitted in at least some embodiments of the present invention.

It is also disclosed herein that, in one embodiment, the mounting bracket structures 140 are omitted and the handle body 128 is integrally formed with the upper arm 126. Through such integration, the handle body 128 and the upper arm 126 become a common handle unit. Accordingly, hand-gripping functionality, beverage container holding functionality and/or indicia display functionality as disclosed herein are each integrated into such common handle unit. Such integration is beneficial in the case where a rollable carrying case is originally manufactured to include handle length extending functionality, hand-gripping functionality, beverage container holding functionality and/or indicia display functionality in accordance with the present invention.

As shown in FIGS. 1-3, the mounting bracket structures 140 are discrete elements with respect to the handle body 128 and the upper arm 126. Such an arrangement for attaching the handle body 128 to the upper arm 126 is useful in an implementation of the present invention where the handle body 128 is an accessory item configured for being attached to the handle assembly of a manufactured rollable carrying case through use of the mounting bracket structures 140 (e.g., an accessory handle assembly configured for attachment to a handle assembly of a rolling cooler). By attaching the handle body 128 to the hand-gripping portion of such a conventional rolling cooler, the handle body 128 extends the overall height of the handle assembly of such a conventional rolling cooler for making use of such a conventional rolling cooler more preferred by taller users and provides for article holding functionality in accordance with the present invention (e.g., beverage container holding functionality).

It is disclosed herein that, in one embodiment, the mounting bracket structures 140 may be fully or partially integral with the handle body 128. For example, one of the mating clamp members 142 of each mounting bracket structure 140 may be integrally formed with the handle body 128 such that the mating clamp members 142 of each mounting bracket structure 140 includes only an engagement feature for being engaged with a handle assembly of a conventional rollable carrying case (e.g., an originally manufactured rolling cooler). In such an embodiment, the mating clamp members 142 are fixedly and permanently attached to the handle body 128 and are suitably configured for being fixedly engaged with a handle assembly of a conventional rollable carrying case. A handle body having such a mounting arrangement is useful for retrofit applications (i.e., being attached to a handle assembly of an originally manufactured rolling cooler).

In the preceding detailed description, reference has been made to the accompanying drawings that form a part hereof, and in which are shown by way of illustration specific embodiments in which the present invention may be practiced. These embodiments, and certain variants thereof, have been described in sufficient detail to enable those skilled in the art to practice embodiments of the present invention. It is to be understood that other suitable embodiments may be utilized and that logical, mechanical, chemical and electrical changes may be made without departing from the spirit or scope of such inventive disclosures. To avoid unnecessary detail, the description omits certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. An accessory handle assembly configured for attachment to a handle assembly of a rollable carrying case, comprising:
a handle body including a hand-gripping portion, wherein the hand-gripping portion enables a person to wrap fingers of one of their hands at least partially therearound;
a mounting bracket structure attached to the handle body, wherein the mounting bracket structure is fixedly attachable to a handle assembly of a rollable carrying case; and
an article holder attached to the handle body.

2. The accessory handle assembly of claim 1 wherein:
the article holder is a beverage container holder; and
the beverage container holder includes a container-receiving space in which a beverage container is stowable.

3. The accessory handle assembly of claim 3, further comprising:
an indicia article attached to the handle body, wherein the indicia article includes indicia designating at least one of a number of a sport competitor, a number of a racing vehicle, a logo of a sport team and a name of a sport team.

4. The accessory handle assembly of claim 4 wherein:
the mounting bracket structure includes retention portions jointly engagable with a handle assembly of the rollable carrying case; and
said retention portions are fixedly securable to each other for applying a retention force on an engaged portion of the handle assembly of the rollable carrying case thereby limiting movement of the handle body with respect to the handle assembly of the rollable carrying case.

5. The accessory handle assembly of claim 1, further comprising:
an indicia article attached to the handle body, wherein the indicia article includes indicia designating at least one of a number of a sport competitor, a number of a racing vehicle, a logo of a sport team and a name of a sport team.

6. The accessory handle assembly of claim 1 wherein:
the mounting bracket structure includes retention portions jointly engagable with a handle assembly of the rollable carrying case; and
said retention portions are fixedly securable to each other for applying a retention force on an engaged portion of the handle assembly of the rollable carrying case thereby limiting movement of the handle body with respect to the handle assembly of the rollable carrying case.

7. The accessory handle assembly of claim 1 wherein:
the handle body includes a rectangular-shaped frame having an upper frame segment, a lower frame segment and spaced apart side frame segments connected between the upper frame segment and the lower frame segment thereby defining an opening between said frame segment;
the hand-gripping portion is integral with the upper frame segment;
the mounting bracket structure is attached to the lower frame segment;
the article holder is a beverage container holder;
the beverage container holder includes a container-receiving space in which a beverage container is stowable; and
the beverage container holder is attached one of said side edge portions.

8. The accessory handle assembly of claim 8 wherein:
the mounting bracket structure includes retention portions jointly engagable with a handle assembly of the rollable carrying case; and
said retention portions are fixedly securable to each other for applying a retention force on an engaged portion of the handle assembly of the rollable carrying case thereby limiting movement of the handle body with respect to the handle assembly of the rollable carrying case.

9. The accessory handle assembly of claim 9, further comprising:
an indicia article attached to the rectangular-shaped frame, wherein the indicia article includes indicia designating at least one of a number of a sport competitor, a number of a racing vehicle, a logo of a sport team and a name of a sport team.

10. A rollable carrying case, comprising:
an enclosure having an interior space in which items may be stored;
wheels attached to the enclosure for enabling the enclosure to be moved along a support surface in a wheeled manner; and
a handle assembly attached to the enclosure, wherein the handle assembly includes a hand-gripping portion and a beverage container holder, wherein the beverage container holder includes a container-receiving space in which a beverage container is stowable.

11. The rollable carrying case of claim 10, further comprising:
an indicia article attached to the handle assembly, wherein the indicia article includes indicia designating at least one of a number of a sport competitor, a number of a racing vehicle, a logo of a sport team and a name of a sport team.

12. The rollable carrying case of claim 10 wherein:
the handle assembly includes a handle body and at least one telescoping structure connected between the handle body and the enclosure, wherein said at least one telescoping structure is movable between a retracted configuration and an extended configuration.

13. The rollable carrying case of claim 12 wherein:
the handle body includes a rectangular-shaped frame having an upper frame segment, a lower frame segment and spaced apart side frame segments connected between the upper frame segment and the lower frame segment thereby defining an opening between said frame segment;
the hand-gripping portion is integral with the upper frame segment;
the mounting bracket structure is attached to the lower frame segment; and
the beverage container holder is attached one of said side edge portions.

14. The rollable carrying case of claim 13, further comprising:
an indicia article attached to the rectangular-shaped frame, wherein the indicia article includes indicia designating at least one of a number of a sport competitor, a number of a racing vehicle, a logo of a sport team and a name of a sport team.

15. A rolling cooler, comprising:
an insulated enclosure including a main body and a cover, wherein the cover is movable between an open configuration where an interior space of the insulated enclosure is accessible and a closed configuration where an opening defining the interior space of the insulated enclosure is substantially covered by the cover;
wheels attached to the insulated enclosure for enabling the insulated enclosure to be moved along a support surface in a wheeled manner; and
a handle assembly attached to the insulated enclosure, wherein the handle assembly includes a hand-gripping portion configured for enabling a person to wrap fingers of one of their hands at least partially therearound and a beverage container holder including a container-receiving space in which a beverage container is stowable.

16. The rolling cooler of claim 15, further comprising:
an indicia article attached to the handle assembly, wherein the indicia article includes indicia designating at least one of a number of a sport competitor, a number of a racing vehicle, a logo of a sport team and a name of a sport team.

17. The rollable carrying case of claim 15 wherein:
the handle assembly includes a handle body and at least one telescoping structure connected between the handle body and the insulated enclosure, wherein said at least one telescoping structure is movable between a retracted configuration and an extended configuration.

18. The rollable carrying case of claim 17 wherein:
the handle body includes a rectangular-shaped frame having an upper frame segment, a lower frame segment and spaced apart side frame segments
connected between the upper frame segment and the lower frame segment
thereby defining an opening between said frame segment; the hand-gripping portion is integral with the upper frame segment; the mounting bracket structure is attached to the lower frame segment; and the beverage container holder is attached one of said side edge portions.

19. The rollable carrying case of claim 18, further comprising:
an indicia article attached to the rectangular-shaped frame, wherein the indicia article includes indicia designating at least one of a number of a sport competitor, a number of a racing vehicle, a logo of a sport team and a name of a sport team.
